(19) United States
(12) Patent Application Publication
(10) Pub. No.: US 2015/0137627 A1
(43) Pub. Date: May 21, 2015

(54) VIBRATION ACTUATOR AND MOBILE INFORMATION TERMINAL

(71) Applicant: Nidec Copal Corporation, Tokyo (JP)

(72) Inventors: Yoshinori KATADA, Tokyo (JP); Yuki SHODA, Tokyo (JP); Yoshihide TONOGAI, Tokyo (JP)

(73) Assignee: NIDEC COPAL CORPORATION, Tokyo (JP)

(21) Appl. No.: 14/538,158

(22) Filed: Nov. 11, 2014

(30) Foreign Application Priority Data
Nov. 11, 2013 (JP) 2013-233533

(51) Int. Cl. H02K 33/00

(52) U.S. Cl. CPC H02K 33/00
USPC 310/25

(57) ABSTRACT

A vibration actuator has a stationary element including a frame, a coil, and a movable element having a magnet and a weight portion. The movable element vibrates in a vibration direction relative to the stationary element. The vibration actuator includes a sliding support member, provided within the frame, extending parallel to the vibration direction at a distance relative to the magnet. The movable element is supported slidably on the sliding support member and relative to the stationary element.

### CROSS REFERENCE TO RELATED APPLICATION

This application claims priority under 35 U.S.C. §119 to Japanese Patent Application No. 2013-233533, filed on Nov. 11, 2013, the entire content of which being hereby incorporated herein by reference.

### FIELD OF TECHNOLOGY

The present invention relates to a vibration actuator and to a mobile information terminal, relating to, for example, a small vibration actuator that is used as a vibration generator for, for example, notifying a user of a mobile information terminal, such as a mobile telephone, that there is an incoming call, or a vibration generator for providing sensory feedback of an operation of a touch panel, or providing an immersive feeling to a game machine, such as a game controller, through propagation to a finger or a hand, and relates to a mobile information terminal that has such a vibration actuator.

### BACKGROUND

There are known vibration actuators that are used in mobile radio devices, and the like. See, for example, Japanese Unexamined Patent Application Publication No. 2012-213683 (the “JP '683”). The vibration actuator set forth in the JP '683 has a structure wherein a shaft passes though a movable element that has a magnet and a weight portion, and the movable element is caused to vibrate along the shaft through cooperation between a coil and a magnet that is disposed within the coil.

Moreover, the vibration actuator set forth in Japanese Unexamined Patent Application Publication No. 2011-97747 (the “JP '747”) has a structure comprising a flat coil that is secured to a frame, a flat magnet that is disposed facing the coil, two shafts that extend in the direction of vibration, and a weight portion, connected to a magnet, that extends through the shaft and is supported slidably by the shaft, wherein the magnet and the weight portion, as movable elements are vibrated along the shaft through cooperation between the coil and the magnet.

However, with the vibration actuator set forth in the JP '683, the structure is one wherein a shaft penetrates through the magnet and weight portion, so if the machining precision of the weight portion is poor, there is the risk that this will produce unnecessary noise. Moreover, if, for example, the vibration actuator is shaped so that the overall height will be low, it is difficult to form the through hole through the magnet and the weight portion.

Moreover, with the vibration actuator set forth in the JP '747, the structure is one wherein a weight portion is caused to slide with two shafts passing therethrough, so if the degree of parallel of the two shafts is low, the movable element will not be able to move smoothly, and thus there is the risk of producing unnecessary noise.

In the present invention, the handling of such problems is one example of the problem to be solved. That is, an aspect of the present invention is to provide a vibration actuator that is able to vibrate, with high precision, a magnet and weight as movable elements, using a simple structure, to provide a thin vibration actuator with a simple structure, and to provide a mobile information terminal that has such a vibration actuator.

### SUMMARY

In order to achieve such an aspect, a vibration actuator according to the present invention is provided with, at least, the following structures: a vibration actuator having a stationary element, including a frame and a coil, and a movable element, having a magnet and a weight portion, for causing the movable element to vibrate linearly in a vibration direction, relative to the stationary element, through cooperation between the coil and the magnet, having a sliding support member that is disposed within the frame and that extends in parallel to the vibration direction, at a distance in relation to the magnet, where the movable element has a structure that is supported so as to enable sliding on the sliding support member, and is supported slidably in relation to the stationary element.

A mobile information terminal according to the present invention has a vibration actuator as described above.

The present invention enables the provision of a vibration actuator that enables high precision vibration of a magnet and a weight portion, as movable elements, through a simple structure. Moreover, the present invention enables provision of a thin vibration actuator with a simple structure. Furthermore, the present invention enables the provision of a mobile information terminal having this vibration actuator.

### BRIEF DESCRIPTIONS OF THE DRAWINGS

FIG. 1 is a front view illustrating one example of a vibration actuator according to an example according to the present invention (a drawing wherein the cover member is omitted).

FIG. 2 is a cross-sectional diagram along the section A-A in the vibration actuator illustrated in FIG. 1.

FIG. 3 is a cross-sectional diagram along the section B-B in the vibration actuator illustrated in FIG. 2.

FIG. 4 is a cross-sectional diagram along the section C-C in the vibration actuator illustrated in FIG. 3.

FIG. 5 is an assembly perspective diagram illustrating one example of a vibration actuator according to an example according to the present invention.

FIG. 6 is a diagram illustrating one example of a mobile information terminal having a vibration actuator according to an example according to the present invention.

### DETAILED DESCRIPTION

An example according to the present invention will be explained below in reference to the drawings. While the example according to the present invention includes the detail that is illustrated, there is no limitation thereto. Note that in the explanations for the various figures below, parts that are in common with those places that have already been explained are assigned identical codes, and redundant explanations are partially omitted.

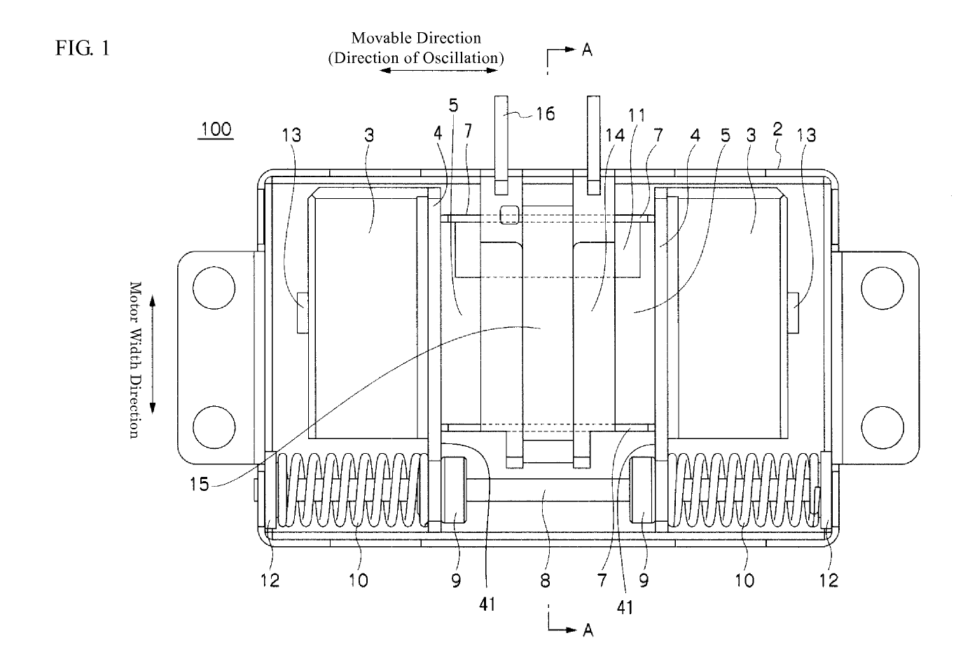

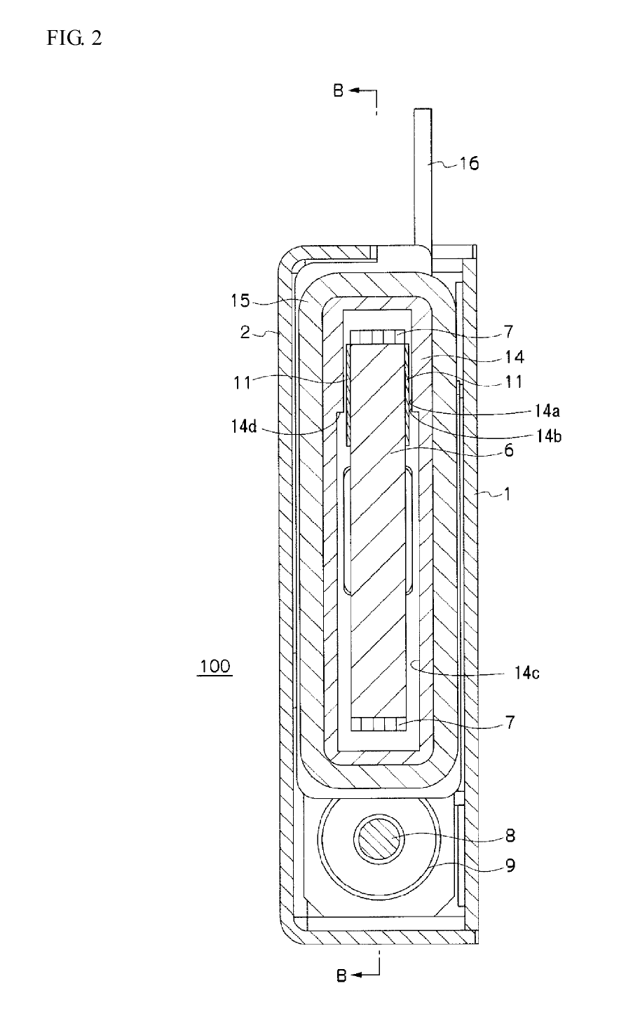

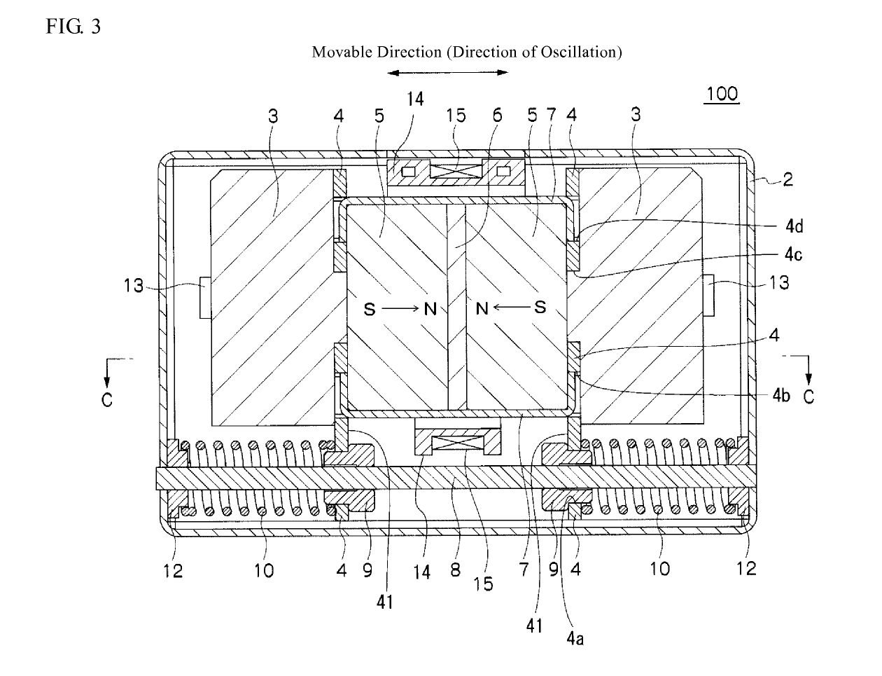

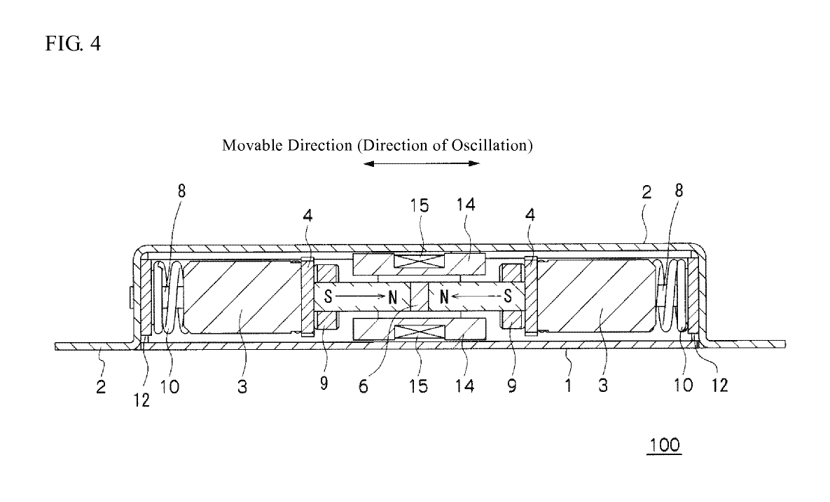

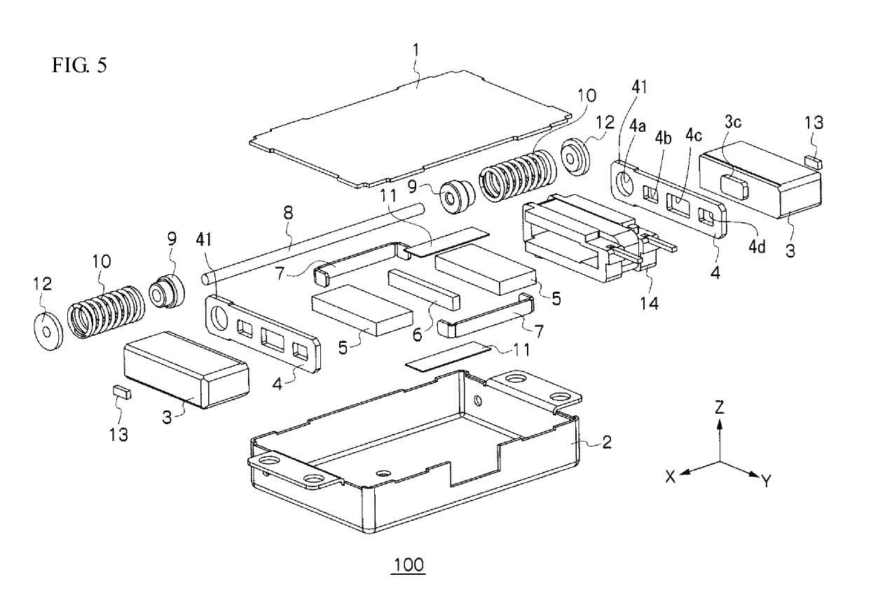

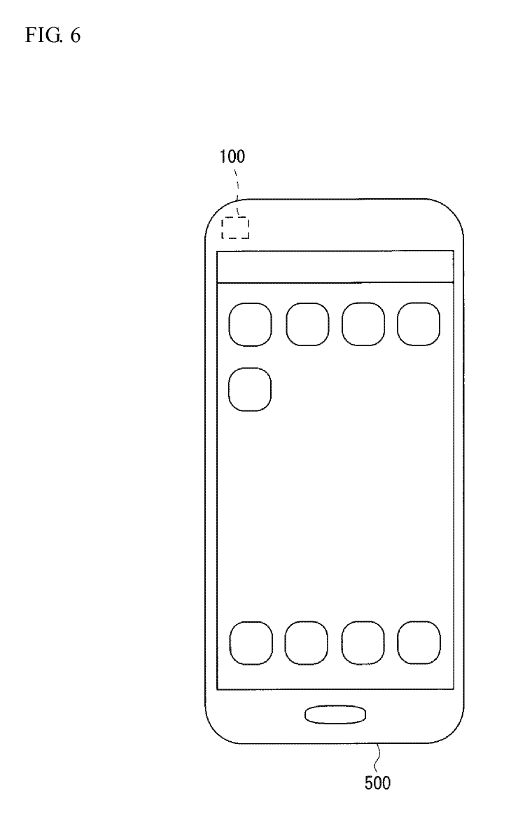

FIG. 1 is a front view diagram illustrating one example of a vibration actuator 100 according to an example according to the present invention. FIG. 2 is a cross-sectional diagram along the section A-A in the vibration actuator 100 illustrated in FIG. 1. FIG. 3 is a cross-sectional diagram along the section B-B in the vibration actuator 100 illustrated in FIG. 2. FIG. 4 is a cross-sectional diagram along the section C-C in the vibration actuator 100 illustrated in FIG. 3. FIG. 5 is an assembly perspective diagram illustrating one example of a vibration actuator 100 according to an example according to the present invention. FIG. 6 is a diagram illustrating one example of a mobile information terminal 500 having a vibration actuator 100 according to an example according to the present invention. Note that in FIG. 1, the cover member 1, provided on the frame 2, is omitted.

A vibration actuator 100 according to an example according to the present invention is structured so that a magnet 5 vibrates linearly, in relation to a coil 15, through cooperation between the coil 15 and the magnet 5. The vibration actuator 100 is installed in a mobile information terminal 500, such as a mobile telephone, a smart phone, a mobile game machine, or the like (referencing FIG. 6). The various structural elements of the vibration actuator 100 will be described in detail below.

The vibration actuator 100 according to the example according to the present invention has a cover member 1, a frame 2 (a case), a weight portion 3, a connecting member 4, a magnet 5, a yoke member 6, a strengthening member 7 (a guide member), a shaft 8 (a sliding support member), a bearing 9, a spring 10 (a biasing member), a low-friction member 11 (a tape), a spring bearing member 12, a shock absorbing member 13 (a cushion), a bobbin 14, a coil 15, and a terminal 16.

The vibration actuator 100 according to the present example has two each of the magnet 5, the weight portion 3, the connecting member 4, the strengthening member 7, the bearing 9, the spring 10, the low-friction member 11, the spring bearing member 12, and the shock absorbing member 13, each disposed with linear symmetry (when not driven) relative to a straight line (a straight line that is perpendicular to the direction of vibration) that passes through the center of the vibration actuator 100.

The vibration actuator 100 has a hollow frame 2 that has a flat shape, where the frame 2 has a cover member 1 (a cover portion) that is attached removably. The bobbin 14 is secured within the frame 2. The bobbin 14 has a cylindrical shape, and is formed in a flat shape. The bobbin 14 is formed from a material such as resin. A coil 15 is wound on to an outer peripheral portion of the bobbin 14, and magnets 5 and 5, which are formed in flat, rectangular shapes, are disposed within the bobbin 14 so as to be able to move in the direction of vibration (the movable direction). A shaft 8, which extends in the direction that is parallel to the direction of vibration of the magnets 5 and 5, is provided at a distance from the magnets 5 and 5. Both ends of the shaft 8 are supported on the frame 2.

In the present example, the two flat rectangular magnets 5 and 5 are secured, by an adhesive agent, or the like, with a yoke member 6 (a center yoke) that is formed from a magnetic material interposed therebetween, and are magnetized, in mutually opposing directions, along the direction of vibration (the movable direction) (referencing FIG. 3). In the example illustrated in FIG. 3, each of the magnets 5 and 5 is magnetized so that the yoke member 6 side is the north pole and the opposite side is the south pole. A coil 15 is disposed on the outer peripheral side of all or part of each of the magnets 5 and 5.

The strengthening members 7 and 7 are formed in U shapes, and are structured from a material such as metal or resin. The strengthening members 7 and 7 have structures wherein the yoke member 6 and portions extending from the respective side edges of the two magnets 5, which have the yoke member 6 interposed therebetween, to portions of the end faces, in the direction of vibration, of each of the magnets 5 are secured together through an adhesive agent, or the like.

The coil 15 is connected electrically through an interconnection to a terminal 16 (a terminal electrode) that is provided on the bobbin 14. The terminal 16 is structured so as to protrude further toward the outside than the frame 2. The structure is such that the magnet 5 will vibrate in the direction of vibration (the axial direction of the shaft 8) when a square wave or sine wave is applied from the outside through the terminal 16.

The weight portions 3 and 3 are formed from metal materials, or the like, and are provided on the end portion sides, in the direction of vibration, of each of the magnets 5 and 5, structured so as to be able to move together with the magnets 5 and 5. The weight portions 3 and 3 are formed in flat shapes. A shock absorbing member 13 (a cushion) is provided on an end portion of the weight portion 3. The provision of the shock absorbing member 13 prevents the production of unnecessary noise, due to the weight portion 3 contacting the inner face of the frame 2, even when a large impulse force is applied from the outside.

The connecting members 4 and 4 are formed in essentially rectangular plate shapes and are provided between the weight portions 3 and 3 and the magnets 5 and 5, secured to the weight portions 3 and 3 and the magnets 5 and 5. The connecting member 4 may be made from a magnetic material such as iron, or from a non-magnetic material such as stainless steel. In the present example, the connecting members 4 and 4 are formed from a metal material. The connecting members 4 and 4 have protruding portions 41 and 41 that protrude further to the shaft 8 side than the magnets 5 and 5, and are supported, either directly by the protruding portions 41 and 41 or through members such as bearings 9 and 9, so as to be able to slide in the direction of vibration along the shaft 8.

In the present example, opening portions 4a, 4b, 4c, and 4d are formed in the connecting member 4 (referencing FIG. 3 and FIG. 5). The shaft 8 is inserted through the opening portion 4a, with the bearing 9 interposed therebetween, the strengthening member 7 engages in the opening portion 4b, and a raised portion 3c, provided on the weight portion 3, fits into the opening portion 4c, and the strengthening member 7 engages with the opening portion 4d. The connecting member 4 has a structure that is joined, through a weld, or the like, to the weight portion 3 and joined, through a weld, or the like, to the strengthening member 7.

Springs 10 and 10 (biasing members) are provided on the shaft 8, wound on to the periphery of the shaft 8, with one end portion each thereof in contact with the frame 2 through a spring bearing member 12, and the other end portions in contact with protruding portions 41, 41 of the connecting members 4, 4. The springs 10 and 10 support the protruding portions 41 and 41 of the connecting members 4 and 4 elastically so as to enable vibration in the direction of vibration. In the present example, coil springs are used for the springs 10 and 10. The structure is such that the biasing forces of the two springs 10 and 10, in the mutually opposing directions, are balanced so that, when not operating, the magnet 5 will stand still at the vibration center position.

The magnet 5 is supported on the shaft 8 through the connecting member 4 so as to be able to slide in the direction of vibration (referencing FIG. 1 and FIG. 3). Moreover, the magnet 5 is a structure that is supported so as to be able slide in the direction of vibration relative to the inner peripheral portion 14a of the bobbin 14.

The vibration actuator 100 has a low-friction member 11, such as a tape, or the like, on the sliding surface of the magnet 5 or of the inner peripheral portion 14a of the bobbin 14, or both. In the present example, the low-friction member 11 is adhered or secured to the sliding surface of the magnet 5 (referencing FIG. 2). The low-friction member 11 is formed from a material with a low coefficient of friction. Additionally, preferably the low-friction member 11 (the tape) is formed from a hard material. Specifically, PEEK (polyetherethylketone), PTFE (polytetrafluoroethylene), or the like, may be used for the material for forming the low-friction member 11. The provision of the low-friction member 11 enables the magnet 5 to slide smoothly relative to the inner peripheral portion 14a of the bobbin 14, with low frictional loss when the magnet 5 is vibrating.

As illustrated in FIG. 2, the inner peripheral portion 14a of the bobbin 14 is formed with the space of the part 14b that is far from the shaft 8 being narrow, and the space of the part 14c that is near to the shaft 8 being wide. In the present example, a step part 14d is formed at the boundary between the part with the narrow space and the part with the wide space. Of the inner peripheral portion 14a of the bobbin 14, the magnet 5 is supported slidably by the part 14b that is far from the shaft 8. Moreover, the low-friction member 11 is provided on the surface of the magnet 5 that faces that part 14b of the inner peripheral portion 14a of the bobbin 14 that is far from the shaft 8.

### Operation of the Vibration Actuator 100

The operation of the vibration actuator 100 will be explained. When not operating, the magnet 5 stands still at the vibration center position. In this case, the biasing forces of the two springs 10 (the biasing members) are in a balanced state.

When a square wave or sine wave current is applied to the coil 15 from the outside through the terminal 16, the temporal variation in the magnetic forces that are produced by the coil 15 and the magnetic forces of the magnet 5 produce a force on the magnet 5 in the direction of vibration, and this force and the biasing force of the springs 10 cause the magnet 5 to vibrate linearly, in the direction of vibration, relative to the coil 15. In this case, the magnet 5 is in a state that is supported by the connecting member 4 so as to be able to slide on the shaft 8, and is in a state that is supported so as to be able to slide in the direction of vibration relative to the inner peripheral portion of the bobbin 14, and so vibrates linearly in the direction of vibration.

As explained above, the vibration actuator 100 according to the example according to the present invention has a stationary element, including a frame 2 and a coil 15, and a movable element, having a magnet 5 and a weight portion 3, where the movable element is vibrated linearly, in the direction of vibration, relative to the stationary element, through cooperation of the coil 15 and the magnet 5. Moreover, the vibration actuator 100 has a shaft 8, as a sliding support member that extends in parallel to the direction of vibration, at a distance relative to the magnet 5. The movable element is structured so as to be supported on the sliding support member (the shaft 8) so as to be able to slide, and also supported so as to be able to slide relative to the stationary element. In a vibration actuator wherein, for example, the movable element is supported by two shafts so as to enable vibration (in the comparative example), the degree of parallel between the two shafts must be high in order to enable smooth movement of the movable element. In the vibration actuator 100 according to the example according to the present invention, as described above, there is no need to consider the degree of parallel, as there is in the comparative example, due to the structure wherein the movable element is supported on a single sliding support member (the shaft 8) so as to be able to slide, and supported so as to be able to slide relative to the stationary member, thus enabling the magnet 5 and the weight portion 3, as the movable element, to vibrate with high precision using a simple structure. Moreover, in this vibration actuator 100, the movable element is able to vibrate smoothly along the axial direction of a single shaft 8, and thus no unnecessary noise is produced.

Moreover, in the example according to the present invention, the movable element has a cross-section, perpendicular to the axial direction of the shaft 8 as the sliding support member, which is essentially a long thin rectangle that faces the sliding support member (the shaft 8), formed in a flat shape that extends in the direction of vibration. Given this, both of the two flat faces on the lengthwise edge sides of the movable element are supported slidably relative to the stationary element. Specifically, the magnet 5 and the weight portion 3 are formed in a flat shape that extends in the direction of vibration and extends in a direction that is perpendicular to the direction of vibration (the motor width direction illustrated in FIG. 1). In the example set forth above, the two long edge side flat surfaces (wide surfaces) of the magnet 5 are each disposed on outer peripheral sides of the magnet 5, and are supported so as to be able to slide relative to the inner peripheral portion 14a of the bobbin 14 of the stationary element, formed as a flat shape. The shaft 8 is disposed on one side in a direct direction (the motor width direction, indicated in FIG. 1) that is perpendicular to the direction of vibration. That is, this enables the provision, through a simple structure, of a thin vibration actuator 100 that enables vibration of the movable element with high precision.

Moreover, the vibration actuator 100 according to the example according to the present invention has a low-friction member on the sliding surface of the movable element or of the stationary element, or both. Specifically, there is a low-friction member 11, such as a tape, on the sliding surface of the magnet 5, the inner peripheral portion 14a of the bobbin 14, or both. Specifically, in the example set forth above, the low-friction member 11 is provided on the sliding surface of the magnet 5. Because of this, the magnet 5 is able to slide smoothly relative to the inner peripheral portion 14a of the bobbin 14, so no unnecessary noise is produced. Moreover, the wear is reduced through forming the low-friction member 11 out of a hard material.

Moreover, in the vibration actuator 100 according to the example according to the present invention, the movable element is supported in slidable contact relative to the stationary element at a part that is far from the sliding support member (the shaft 8). In the example set forth above, the magnet 5, as the movable element, can be caused to vibrate smoothly, in the direction of vibration, in a state wherein the deflection of the magnet 5, as the movable element (that is, the deflection around the shaft 8 as the rotational axis) is suppressed, due to being supported slidably by the inner peripheral portion 14a of the bobbin 14 at a part that is relatively far from the shaft 8. Specifically, the part 14b that is far from the shaft 8 in the inner peripheral portion 14a of the bobbin 14 is formed so as to have a narrow space, and the magnet 5 is supported in slidable contact relative to the inner peripheral portion 14a of the bobbin 14 at a part, of the region that has a surface that faces the inner peripheral portion 14a of the bobbin 14, that is far from the shaft 8, and the low-friction member 11 is provided at this part. As a result, this enables smooth vibration, in the direction of vibration, in a state wherein the deflection of the magnet 5 (deflection around the shaft 8, as the rotational axis) is suppressed as to be small.

Moreover, the inner peripheral portion 14a of the bobbin 14 in the example set forth above is formed so as to have narrow spacing at the part 14b that is far from the shaft 8 and so as to have wide spacing at the part 14c that is near to the shaft 8. As a result, this enables prevention of contact of the magnet 5 with the part 14c that is near to the shaft 8 in the inner peripheral portion 14a of the bobbin 14 even if there is a roughness formed in the surface of the magnet 5 due to the machining tolerance at the time of manufacturing of the magnet 5.

Furthermore, the vibration actuator 100 according to the example according to the present invention has a connecting member 4 (a back yoke) that is provided between the magnet 5 and the weight portion 3, secured to the magnet 5 and the weight portion 3, where the connecting member 4 has a protruding portion 41 that protrudes further toward the sliding support member side (the shaft 8 side) than the magnet 5, to be supported by this protruding portion 41 on the sliding support member (the shaft 8) so as to be able to slide in the direction of vibration. The spring 10, as a biasing member, supports the protruding portion 41 of the connecting member 4 elastically so as to enable vibration in the direction of vibration. Because of this, the magnet 5 and the weight portion 3, as the movable element, can be supported through the connecting member 4, using a simple structure, so as to be able to slide on the shaft 8.

Moreover, in the example according to the present invention there is a first magnet 5 and a second magnet 5. Specifically, the first magnet 5 and the second magnet 5 are secured, through an adhesive agent, or the like, with a yoke member 6 (a center yoke) interposed therebetween, and are magnetized in mutually opposing directions along the direction of vibration (the movable direction). Given this, a coil 15 is provided on the outer peripheral side of all or part of the first magnet 5 and the second magnet 5. That is, this enables increased density of the magnetic force lines in the vicinity of the yoke member 6, enabling the magnets 5 and 5 to be vibrated/driven along the direction of vibration with large forces when the vibration actuator 100 is operated.

Moreover, the vibration actuator 100 according to the example according to the present invention has strengthening members 7 and 7 (guide members) secured across a yoke member 6 (a center yoke) and a portion from the respective side surfaces of the two magnets 5 and 5 to the end portions, in the direction of vibration, of the respective magnets 5 and 5, between which the yoke member 6 is interposed. In the present example, the yoke member 6 and the two magnets 5 and 5 are bonded and secured, through an adhesive agent, or the like, by the two U -shaped strengthening members 7 and 7 (guide members) in a state wherein the yoke member 6 and the individual magnets 5 and 5 are secured together through an adhesive agent, or the like. The provision of the strengthening members 7 and 7 in this way causes the two flat and thin magnets 5 and 5 and the yoke member 6 (the center yoke) to have high strength relative to outside forces. In other words, this enables provision of a vibration actuator 100 that is highly rugged in relation to a drop impact.

Moreover, the vibration actuator 100 according to the example according to the present invention has spring bearing members 12 and 12 between the springs 10 and 10 (the biasing members) and the inner surface of the frame 2. That is, the end portions of the springs 10 and 10 can be caused, by the spring bearing members 12 and 12, to contact prescribed positions of the inner surface of the frame 2. Note that the spring bearing members 12 and 12 and the springs 10 and 10 may be secured together.

Moreover, in the example according to the present invention, the mobile information terminal 500 has a vibration actuator 100 that is small and thin, thus enabling the provision of a mobile information terminal 500 that is small and thin. Moreover, when the vibration actuator 100 is installed in the mobile information terminal 500, the space for installing the vibration actuator 100 is extremely small.

While examples according to the present invention were explained in detail above referencing the drawings, the specific structure is not limited to these examples, but rather design changes, and the like, within a range that does not deviate from the spirit and intent of the present invention are also included within the present invention. Furthermore, in the examples illustrated in the various drawing is described above, the details that are set forth in the various drawings may be combined together insofar as there are no particular problems or contradictions with the purposes, structures, and the like, thereof. Moreover, the details set forth in the various drawings may form examples that are independent of each other, and the examples according to the present invention are not limited to a single example that combines the drawings.

In the example set forth above, the connecting member 4 was disposed between the weight portion 3 and the magnet 5, and secured to the weight portion 3 and the magnet 5; however, there is no limitation to this form. For example, the connecting member 4 may be secured to a prescribed position of the weight portion 3. Moreover, the strengthening member 7 and the connecting member 4, and the like, may be formed as a monolithic unit. Furthermore, the magnet 5 may be structured so as to be supported so as to be able to slide at a position of the inner peripheral portion 14a of the bobbin 14 that is near to the shaft 8. Additionally, while, in the example set forth above, the connecting member 4 has a protruding portion 41 that protrudes further than the magnet 5 toward the shaft 8 side, and is supported by the protruding portion 41 so as to be able to slide on the shaft 8, there is no limitation to this form. For example, instead the weight portion 3 may protrude further than the magnet 5 toward the shaft 8 side, and may be supported by that protruding portion so as to be able to slide on the shaft 8. Additionally, while, in the example set forth above, the magnet 5 of the movable element was structured so as to be supported slidably relative to the bobbin 14 as the stationary element, there is no limitation to this form. For example, the weight portion 3 of the movable element may be structured to be supported so as to be able to slide relative to a stationary element such as the bobbin 14, the frame 2, the cover member 1, or the like.

1: A vibration actuator having a stationary element comprising a frame and a coil, and a movable element having a magnet and a weight portion, wherein the movable element vibrates in a vibration direction relative to the stationary element, the vibration actuator comprising:
a sliding support member, provided within the frame, extending parallel to the vibration direction at a distance relative to the magnet, wherein
the movable element is supported slidably on the sliding support member, and supported slidably relative to the stationary element.

2: The vibration actuator as set forth in claim 1, wherein,
in the movable element, the cross-section that is perpendicular to an axial direction of the sliding support member is essentially a long, thin rectangle that faces the sliding support member, and is formed in a flat shape that extends in the vibration direction, and
the flat faces on the two long edge sides of the movable element are slidably supported relative to the stationary element.

3: The vibration actuator as set forth in claim 1, wherein
a low-friction member is provided on a sliding surface of the movable element, the stationary element, or both.

4: The vibration actuator as set forth in claim 1, wherein
the movable element is supported in contact at a part that is far from the sliding support member and slidably supported relative to the stationary element.

5: The vibration actuator as set forth in claim 1, wherein
a connecting member is provided between the magnet and the weight portion and secured to the magnet and the weight portion,
the connecting member has a protruding portion that protrudes further than the magnet toward the sliding support member side,
the connecting member is supported by the protruding member on the sliding support member and slidably supported along the vibration direction, and wherein at least one end portion thereof has a biasing member that is in contact with the frame and that supports the protruding portion of the connecting member elastically so as to enable vibration in the vibration direction.

6: A mobile information terminal comprising:
a vibration actuator having a stationary element comprising a frame and a coil, and a movable element having a magnet and a weight portion, wherein the movable element vibrates in a vibration direction relative to the stationary element, the vibration actuator comprising:
a sliding support member, provided within the frame, extending parallel to the vibration direction at a distance relative to the magnet, wherein
the movable element is supported slidably on the sliding support member, and supported slidably relative to the stationary element.
